(19) United States
(12) Patent Application Publication
(10) Pub. No.: US 2018/0041431 A1
(43) Pub. Date: Feb. 8, 2018

(54) VIRTUALIZED INTERNET PROTOCOL (IP) PACKET PROCESSING SYSTEM

(71) Applicant: QUALCOMM Incorporated, San Diego, CA (US)

(72) Inventors: Shaul Yohai Yifrach, Haifa (IL); Tomer Rafael Ben-Chen, Amikan (IL); Amit Gil, Zichron Yaakov (IL); Dan Gilboa Waizman, Atlit (IL); Deepak Jindal, Bangalore (IN)

(21) Appl. No.: 15/226,383

(22) Filed: Aug. 2, 2016

(51) Int. Cl. H04L 12/713; H04L 29/12; H04L 12/725; H04L 12/863

(52) U.S. Cl. CPC H04L 45/586; H04L 47/624; H04L 61/2521; H04L 45/306

(57) ABSTRACT

A virtualized Internet Protocol (IP) packet processing system is provided. In this regard, in one aspect, a computing circuit for processing IP packets is shared among a plurality of virtual clients. The computing circuit includes a plurality of hardware functional blocks each configured to perform a predefined IP packet processing function. In another aspect, a virtual channel is created for each of the virtual clients and assigned with one or more of the hardware functional blocks. In this regard, IP packets associated with each of the virtual clients may be processed by respective assigned hardware functional blocks based on a specified processing sequence. By sharing the computing circuit among the virtual clients and assigning respective hardware functional blocks to each virtual client, it is possible to optimize processing efficiency of the computing circuit, thus improving throughput, latency, and power consumption of the virtualized IP packet processing system.

### BACKGROUND

### I. Field of the Disclosure

The technology of the disclosure relates generally to Internet Protocol (IP) packet processing in an electronic device.

### II. Background

Mobile communication devices have become increasingly common in current society. The prevalence of these mobile communication devices is driven in part by the many functions that are now enabled on such devices. Increased processing capabilities in such devices means that mobile communication devices have evolved from being pure communication tools into sophisticated mobile multimedia centers that enable enhanced user experiences.

Mobile communication devices are increasingly capable of providing a variety of communication services based on a variety of communication protocols. For example, mobile communication devices are often configured to provide wide-area wireless communication services (e.g., long-term evolution (LTE)), local-area wireless communication services (e.g., Wi-Fi), and local-area wired communication services (e.g., Ethernet).

Internet Protocol (IP) is a data communication protocol created by the Internet Engineering Task Force (IETF) for providing a common data transport mechanism across the variety of communication protocols (e.g., LTE communication protocol, Wi-Fi communication protocol, and Ethernet communication protocol). In this regard, application-specific data are first encoded into IP packets before being communicated based on communication protocols corresponding to the variety of communication services. IP packet processing is a heavy task and usually requires dedicated hardware and/or software support in the mobile communication devices. As such, it is desired to optimize efficiency of dedicated IP packet processing hardware, thus achieving increased data throughput, decreased processing latency, and reduced power consumption in the mobile communication devices.

### SUMMARY OF THE DISCLOSURE

Aspects disclosed in the detailed description include a virtualized Internet Protocol (IP) packet processing system. In this regard, in one aspect, a computing circuit for processing IP packets is shared among a plurality of virtual clients. The computing circuit includes a plurality of hardware functional blocks each configured to perform a predefined IP packet processing function (e.g., IP packet header ciphering/deciphering, IP packet header filtering, and IP packet payload processing). In another aspect, a virtual channel is created for each of the virtual clients and assigned with one or more of the hardware functional blocks. In this regard, IP packets associated with each of the virtual clients may be processed by respective assigned hardware functional blocks based on a specified processing sequence. By sharing the computing circuit among the virtual clients and assigning respective hardware functional blocks to each virtual client, it is possible to optimize processing efficiency of the computing circuit, thus improving throughput, latency, and power consumption of the virtualized IP packet processing system.

In this regard, in one aspect, a virtualized IP packet processing system is provided. The virtualized IP packet processing system includes a client interface. The client interface is configured to be coupled to a plurality of virtual clients. The virtualized IP packet processing system also includes hardware-based IP packet processing circuitry including a computing circuit. The computing circuit includes a plurality of hardware functional blocks each configured to perform a predefined IP packet processing function. The virtualized IP packet processing system also includes a resource controller. The resource controller is configured to receive an IP process request from a virtual client among the plurality of virtual clients via the client interface to perform a predefined IP packet process. The resource controller is also configured to define a virtual channel for the virtual client. The resource controller is also configured to assign one or more hardware functional blocks among the plurality of hardware functional blocks to the virtual channel based on the predefined IP packet process. The resource controller is also configured to configure the one or more assigned hardware functional blocks to perform the predefined IP packet process according to a specified processing sequence.

In another aspect, a virtualized IP packet processing system is provided. The virtualized IP packet processing system includes a means for coupling to a plurality of virtual clients. The virtualized IP packet processing system also includes a means for processing IP packets. The means for processing IP packets includes a computing circuit. The computing circuit includes a plurality of hardware functional blocks each configured to perform a predefined IP packet processing function. The virtualized IP packet processing system also includes a means for controlling resources. The means for controlling resources is configured to receive an IP process request from a virtual client among the plurality of virtual clients via a client interface to perform a predefined IP packet process. The means for controlling resources is also configured to define a virtual channel for the virtual client. The means for controlling resources is also configured to assign one or more hardware functional blocks among the plurality of hardware functional blocks to the virtual channel based on the predefined IP packet process. The means for controlling resources is also configured to configure the one or more assigned hardware functional blocks to perform the predefined IP packet process according to a specified processing sequence.

In another aspect, a method for processing IP packets is provided. The method includes receiving an IP process request from a virtual client among a plurality of virtual clients via a client interface to perform a predefined IP packet process. The method also includes defining a virtual channel for the virtual client. The method also includes assigning one or more hardware functional blocks among a plurality of hardware functional blocks to the virtual channel based on the predefined IP packet process. Each of the plurality of hardware functional blocks is configured to perform a predefined IP packet processing function. The method also includes configuring the one or more assigned hardware functional blocks to perform the predefined IP packet process according to a specified processing sequence.

### BRIEF DESCRIPTION OF THE FIGURES

FIG. 1A is a schematic diagram of an exemplary Internet Protocol (IP) version 4 (IPv4) packet as defined by the Internet Engineering Task Force (IETF);

FIG. 1B is a schematic diagram of an exemplary IP version 6 (IPv6) packet as defined by the IETF;

FIG. 2 is a schematic diagram of an exemplary conventional electronic device configured to process IP packets for a plurality of application-specific clients based on a plurality of IP packet processing functions, respectively

FIG. 3 is a schematic diagram of an exemplary electronic device including a virtualized IP packet processing system configured to perform IP packet processing for a plurality of virtual clients;

FIG. 4 is a flowchart of an exemplary process that may be performed by a resource controller in the virtualized IP packet processing system of FIG. 3 for processing IP packets based on a predefined IP packet process; and

FIG. 5 illustrates an example of a processor-based system that can support the virtualized IP packet processing system of FIG. 3.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include a virtualized Internet Protocol (IP) packet processing system. In this regard, in one aspect, a computing circuit for processing IP packets is shared among a plurality of virtual clients. The computing circuit includes a plurality of hardware functional blocks each configured to perform a predefined IP packet processing function (e.g., IP packet header ciphering/deciphering, IP packet header filtering, and IP packet payload processing). In another aspect, a virtual channel is created for each of the virtual clients and assigned with one or more of the hardware functional blocks. In this regard, IP packets associated with each of the virtual clients may be processed by respective assigned hardware functional blocks based on a specified processing sequence. By sharing the computing circuit among the virtual clients and assigning respective hardware functional blocks to each virtual client, it is possible to optimize processing efficiency of the computing circuit, thus improving throughput, latency, and power consumption of the virtualized IP packet processing system.

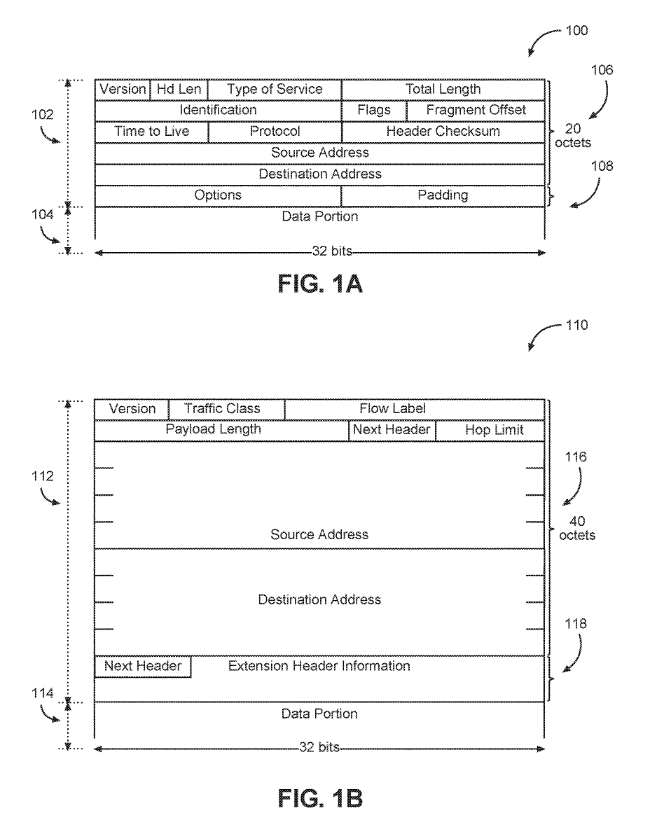

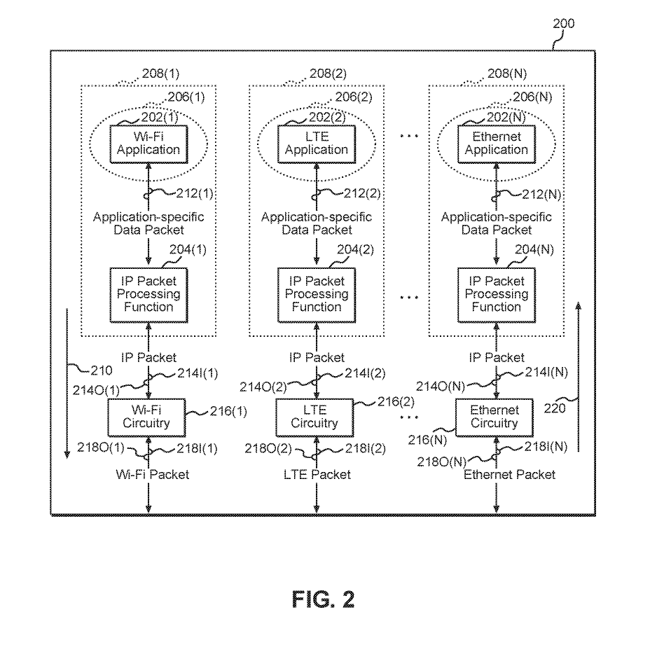

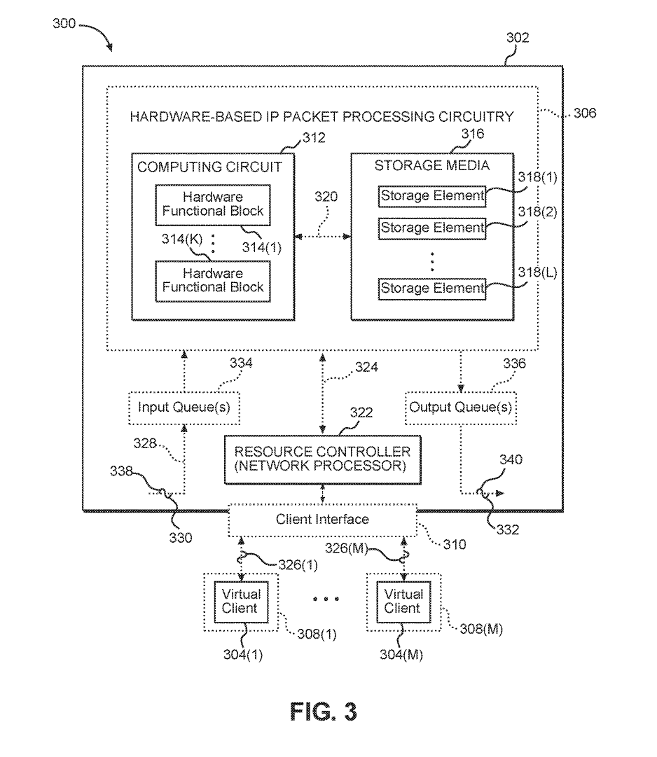

Before discussing exemplary aspects of a virtualized IP packet processing system that includes specific aspects of the present disclosure, a brief overview of IP version 4 (IPv4) and IP version 6 (IPv6) packet formats is first provided in FIGS. 1A and 1B, respectively. A brief discussion of IP packet processing in a conventional electronic device is then discussed with reference to FIG. 2. The discussion of specific exemplary aspects of a virtualized IP packet processing system starts with reference to FIG. 3.

In this regard, FIG. 1A is a schematic diagram of an exemplary IPv4 packet 100 as defined by the Internet Engineering Task Force (IETF). The IPv4 packet 100 includes an IPv4 packet header 102 and an IPv4 packet payload 104. The IPv4 packet header 102 includes control information describing the IPv4 packet 100 (e.g., type of service, total length, source address, destination address, etc.). The IPv4 packet header 102 includes a fix-length header section 106 and a variable-length header section 108. According to the IETF definition, the fix-length header section 106 is twenty (20) octets in length and the variable-length header section 108 is variable in length. The IPv4 packet payload 104 is configured to contain encoded data (e.g., application-specific data). The IPv4 packet payload 104 is also variable in length. The IPv4 packet payload 104 may be omitted from the IPv4 packet 100, thus making the IPv4 packet 100 a header-only IPv4 packet.

FIG. 1B is a schematic diagram of an exemplary IPv6 packet 110 as defined by the IETF. The IPv6 packet 110 includes an IPv6 packet header 112 and an IPv6 packet payload 114. The IPv6 packet header 112 includes control information describing the IPv6 packet 110 (e.g., type of service, total length, source address, destination address, etc.). The IPv6 packet header 112 includes a fix-length header section 116 and a variable-length header section 118. According to the IETF definition, the fix-length header section 116 is forty (40) octets in length and the variable-length header section 118 is variable in length. The IPv6 packet payload 114 is configured to contain encoded data (e.g., application-specific data). The IPv6 packet payload 114 is also variable in length. The IPv6 packet payload 114 may be omitted from the IPv6 packet 110, thus making the IPv6 packet 110 a header-only IPv6 packet.

IP packets (e.g., the IPv4 packet 100 and the IPv6 packet 110) can provide common data transport across a variety of communication protocols (e.g., long-term evolution (LTE) communication protocol, Wi-Fi communication protocol, and Ethernet communication protocol). In this regard, FIG. 2 is a schematic diagram of an exemplary conventional electronic device 200 configured to process IP packets for a plurality of application-specific clients 202(1)-202(N) based on a plurality of IP packet processing functions 204(1)-204(N), respectively.

With reference to FIG. 2, the conventional electronic device 200 is configured to support concurrently a plurality of operating systems (OSs) 206(1)-206(N). For example, the OS 206(1) is an Android OS, the OS 206(2) is a Linux OS, and the OS 206(N) is a Windows OS. In a non-limiting example, the application-specific client 202(1) is a Wi-Fi application running in the Android OS 206(1), the application-specific client 202(2) is an LTE application running in the Linux OS 206(2), and the application-specific client 202(N) is an Ethernet application running in the Windows OS 206(N). The OSs 206(1)-206(N) are confined in a plurality of execution environments 208(1)-208(N), respectively. The execution environments 208(1)-208(N) are allocated with respective system resources (e.g., central processing units (CPUs) and system memory) and are isolated from other execution environments 208(1)-208(N). Hence, the execution environments 208(1)-208(N) are virtualized execution environments. Accordingly, the OSs 206(1)-206(N) are virtualized OSs and the application-specific clients 202(1)-202(N) are virtual clients.

In a transmit direction 210, the application-specific clients 202(1)-202(N) provide application-specific data packets 212(1)-212(N) to the IP packet processing functions 204(1)-204(N), respectively. The IP packet processing functions 204(1)-204(N) are configured to encode the application-specific data packets 212(1)-212(N) into IP packets 214O(1)-214O(N), respectively. The IP packets 214O(1)-214O(N) are received by a plurality of communication circuits 216(1)-216(N), respectively. In a non-limiting example, the communication circuit 216(1) is a Wi-Fi circuit, the communication circuit 216(2) is an LTE circuit, and the communication circuit 216(N) is an Ethernet circuit. The communication circuits 216(1)-216(N) encode the IP packets 214O(1)-214O(N) into medium access control (MAC) packets 218O(1)-218O(N), respectively. In a non-limiting example, the MAC packet 218O(1) is encoded according to Wi-Fi communication protocol, the MAC packet 218O(2) is encoded according to LTE communication protocol, and the MAC packet 218O(N) is encoded according to Ethernet communication protocol.

In a receive direction 220, the communication circuits 216(1)-216(N) decode a plurality of MAC packets 218I(1)-218I(N) into a plurality of IP packets 214I(1)-214I(N), respectively. The IP packet processing functions 204(1)-204(N) in turn decode the IP packets 214I(1)-214I(N) into the application-specific data packets 212(1)-212(N), respectively.

With continuing reference to FIG. 2, the IP packet processing functions 204(1)-204(N) are software functions executing in the execution environments 208(1)-208(N), respectively. As such, the IP packet processing functions 204(1)-204(N) can introduce processing delays when encoding the IP packets 214O(1)-214O(N) and decoding the IP packets 214I(1)-214I(N). As data rates of the communication circuits 216(1)-216(N) exceed one (1) gigabit per second (1 Gbps), the processing delays associated with the software-based IP packet processing functions 204(1)-204(N) are no longer negligible. As a result, the software-based IP packet processing functions 204(1)-204(N) are replaced by dedicated IP packet processing hardware to help reduce the processing latency. However, replacing each of the software-based IP packet processing functions 204(1)-204(N) with a respective IP packet processing hardware can lead to significant increases in footprint, cost, and/or power consumption. To reduce these concerns, exemplary aspects of the present disclosure replace the software-based IP packet processing functions 204(1)-204(N) with a common IP packet processing hardware and share the common IP packet processing hardware among application-specific clients.

In this regard, FIG. 3 is a schematic diagram of an exemplary electronic device 300 including a virtualized IP packet processing system 302 configured to perform IP packet processing for a plurality of virtual clients 304(1)-304(M). The virtualized IP packet processing system 302 is configured to process the IPv4 packet 100 of FIG. 1A and/or the IPv6 packet 110 of FIG. 1B. The virtualized IP packet processing system 302 includes hardware-based IP packet processing circuitry 306. In a non-limiting example, the hardware-based IP packet processing circuitry 306 provides a means for processing IP packets in the electronic device 300. By sharing the hardware-based IP packet processing circuitry 306 among the virtual clients 304(1)-304(M), it is possible to reduce the processing latency associated with the IP packet processing functions 204(1)-204(N) of FIG. 2 without increasing footprint, cost, and/or power consumption of the electronic device 300.

With reference to FIG. 3, in a non-limiting example, the virtual clients 304(1)-304(M) are confined in a plurality of virtual execution environments 308(1)-308(M), respectively. Each of the virtual execution environments 308(1)-308(M) is configured to support a respective OS (e.g., Android OS, Linux OS, and Windows OS).

The virtualized IP packet processing system 302 may include a client interface 310 configured to be coupled to the virtual clients 304(1)-304(M). As such, the virtual clients 304(1)-304(M) are communicatively coupled to the virtualized IP packet processing system 302. In this regard, in a non-limiting example, the client interface 310 provides a means for coupling the virtualized IP packet processing system 302 to the virtual clients 304(1)-304(M).

The hardware-based IP packet processing circuitry 306 includes a computing circuit 312. The computing circuit 312 includes a plurality of hardware functional blocks 314(1)-314(K). Each of the hardware functional blocks 314(1)-314(K) is configured to perform a predefined IP packet processing function. In a non-limiting example, the hardware functional blocks 314(1)-314(K) are configured to perform a variety of predefined IP packet processing functions, including an IP packet header deciphering function, an IP packet header ciphering function, an IP packet header filtering function, an IP packet header checksum function, an IP packet header insertion function, an IP packet header removal function, an IP packet payload processing function, an IP packet aggregation function, an IP packet de-aggregation function, an IP packet routing function, and an IP packet network address translation (NAT) function. In another non-limiting example, the hardware functional blocks 314(1)-314(K) are also configured to support direct memory access (DMA) for non-IP based data. For example, each of the hardware functional blocks 314(1)-314(K) can be configured to support a general DMA copy (e.g., data movement for a non-IP channel) and/or non-IP control messages (e.g., sending in-band, non-IP control message within an IP data stream).

The hardware-based IP packet processing circuitry 306 includes storage media 316. The storage media 316 includes a plurality of storage elements 318(1)-318(L) (e.g., registers). The computing circuit 312 is communicatively coupled to the storage media 316 via a connection path 320. The connection path 320 may be a direct connection path or an indirect connection path between the computing circuit 312 and the storage media 316.

With continuing reference to FIG. 3, the virtualized IP packet processing system 302 includes a resource controller 322 that is communicatively coupled to the hardware-based IP packet processing circuitry 306 via a communication path 324. The communication path 324 may be a direct or an indirect communication path between the resource controller 322 and the hardware-based IP packet processing circuitry 306. In a non-limiting example, the resource controller 322 is a network processor 322 of a communication circuit (e.g., LTE modem) (not shown) in the electronic device 300. The resource controller 322 is configured to allocate IP packet processing resources, such as the hardware functional blocks 314(1)-314(K) and the storage elements 318(1)-318(L), to the virtual clients 304(1)-304(M). In this regard, in a non-limiting example, the resource controller 322 provides a means for controlling resources in the electronic device 300.

The resource controller 322 receives one or more IP process requests 326(1)-326(M) from the virtual clients 304(1)-304(M), respectively, via the client interface 310. Each of the IP process requests 326(1)-326(M) requests the virtualized IP packet processing system 302 to perform a predefined IP packet process. As is further discussed later, the predefined IP packet process includes an IP packet encoding process and an IP packet decoding process.

For the convenience of reference and discussion, the virtual client 304(1) is discussed and illustrated hereinafter as a non-limiting example. It shall be appreciated that the configuration and operation principles discussed hereinafter with reference to the virtual client 304(1) are applicable to the virtual clients 304(2)-304(M) as well.

With continuing reference to FIG. 3, the resource controller 322 receives the IP process request 326(1) from the virtual client 304(1) via the client interface 310 to perform the predefined IP packet process. In response to receiving the IP process request 326(1), the resource controller 322 defines a virtual channel 328 for the virtual client 304(1). In a non-limiting example, the virtual channel 328 is a logical representation of the virtual client 304(1) and the IP packet processing resources allocated to perform the predefined IP packet process requested by the virtual client 304(1). In another non-limiting example, the virtual channel 328 includes a plurality of physical channels (not shown) each configured to communicate a respective virtual channel flow with the virtual client 304(1). In this regard, the resource controller 322 assigns one or more hardware functional blocks (hereinafter referred to as “assigned hardware functional blocks 314”) among the hardware functional blocks 314(1)-314(K) to the virtual channel 328 for performing the predefined IP packet process requested by the virtual client 304(1).

The resource controller 322 determines the assigned hardware functional blocks 314 based on the predefined IP packet process. For example, when the predefined IP packet process is the IP packet encoding process, the assigned hardware functional blocks 314 may include hardware functional blocks configured to provide the IP packet header ciphering function, the IP packet header checksum function, the IP packet header insertion function, and the IP packet payload processing function. Alternatively, when the predefined IP packet process is the IP packet decoding process, the assigned hardware functional blocks 314 may include hardware functional blocks configured to provide the IP packet header removal function, the IP packet header deciphering function, and the IP packet header checksum function.

Subsequent to assigning the assigned hardware functional blocks 314 to the virtual channel 328, the resource controller 322 configures the assigned hardware functional blocks 314 to perform the predefined IP packet process according a specified processing sequence. In a non-limiting example, the specified processing sequence defines an execution order for the assigned hardware functional blocks 314. As previously mentioned, the virtual channel 328 may include physical channels each configured to communicate a respective virtual channel flow with the virtual client 304(1). As such, the specified processing sequence may be determined based on the respective virtual channel flow. In this regard, it may be possible to define a plurality of specified processing sequences for the physical channels included in the virtual channel 328. According to the above example of the IP packet encoding process, the specified processing sequence indicates that the IP packet encoding process is performed in the order of IP packet header ciphering, IP packet header checksum, IP packet header insertion, and IP packet payload processing. The resource controller 322 may determine the specified processing sequence based on IP packet processing information received in the IP process request 326(1).

In a first non-limiting example, the virtual client 304(1) is in a transmit mode, and the predefined IP packet process is the IP packet encoding process. The virtual client 304(1) can indicate selection of the IP packet encoding process in the IP process request 326(1). In this regard, the virtual client 304(1) provides one or more application-specific packets 330 to the virtualized IP packet processing system 302 for encoding into one or more IP packets 332. The application-specific packets 330 may be encoded in the transport control protocol (TCP) packet format, the user datagram protocol (UDP) packet format, or other packets formats as appropriate. The virtual client 304(1) may provide the application-specific packets 330 to the virtualized IP packet processing system 302 either via the client interface 310 or via alternative connection paths (e.g., system bus) (not shown) in the electronic device 300.

The assigned hardware functional blocks 314 receive the application-specific packets 330 from an input queue 334 in a first packet order. The input queue 334 is communicatively coupled to the hardware-based IP packet processing circuitry 306 and, thus is accessible to the assigned hardware functional blocks 314. The assigned hardware functional blocks 314 encode the application-specific packets 330 into the IP packets 332 according to the specified processing sequence. The assigned hardware functional blocks 314 add the IP packets 332 into an output queue 336 in a second packet order, which may be identical to or different from the first packet order. The IP packets 332 can be retrieved from the output queue 336 by a communication circuit (not shown) (e.g., LTE communication circuit, Wi-Fi communication circuit, Ethernet communication circuit, etc.) in the electronic device 300 for further encoding.

In a second non-limiting example, the virtual client 304(1) is in a receive mode, and the predefined IP packet process is the IP packet decoding process. The virtual client 304(1) can indicate selection of the IP packet decoding process in the IP process request 326(1). In this regard, the assigned hardware functional blocks 314 receive one or more IP packets 338 from the input queue 334 in the first packet order. The IP packets 338 may be received from the communication circuit (e.g., LTE communication circuit, Wi-Fi communication circuit, Ethernet communication circuit, etc.) in the electronic device 300. The assigned hardware functional blocks 314 decode the IP packets 338 into one or more application-specific packets 340 according to the specified processing sequence. The assigned hardware functional blocks 314 add the application-specific packets 340 to the output queue 336 in the second packet order, which may be identical to or different from the first packet order. The virtual client 304(1) may retrieve the application-specific packets 340 from the output queue 336 either via the client interface 310 or via alternative connection paths (e.g., system bus) in the electronic device 300.

With continuing reference to FIG. 3, the resource controller 322 is configured to allocate one or more storage elements (hereinafter referred to as “allocated storage elements 318”) among the storage elements 318(1)-318(L) to the virtual channel 328. In a non-limiting example, the assigned hardware functional blocks 314 store the IP packets 332, either intermediate or completed, in the allocated storage elements 318 while performing the predefined IP packet process. In this regard, the amount of the allocated storage elements 318 can affect performance (e.g., processing latency, packet encoding/decoding rate, etc.) of the assigned hardware functional blocks 314. As such, the resource controller 322 is configured to allocate dynamically the allocated storage elements 318 based on quality-of-service (QoS) requirements of the virtual channel 328. The resource controller 322 can allocate the allocated storage elements 318 dynamically based on bandwidth requirement and/or latency requirement of the virtual channel 328. In a non-limiting example, the resource controller 322 can dynamically increase the allocated storage elements 318 if the virtual channel 328 demands higher bandwidth and/or lower latency. In contrast, the resource controller 322 can dynamically decrease the allocated storage elements 318 if the virtual channel 328 can tolerate lower bandwidth and/or higher latency.

The allocated storage elements 318 are accessible exclusively by the virtual channel 328, thus providing security protection to the virtual channel 328 and the virtual client 304(1). In a non-limiting example, it is possible to associate the virtual channel 328 with a respective security credential.

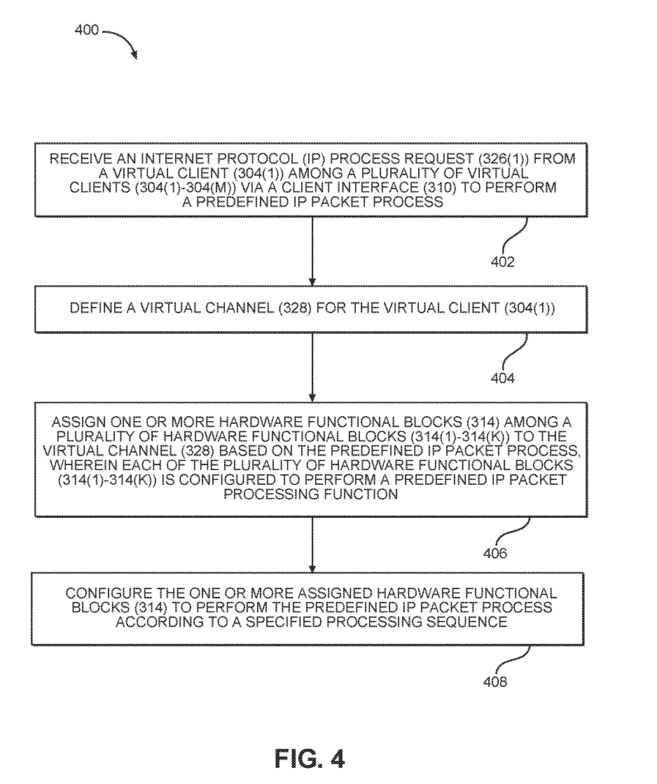

The resource controller 322 may configure the assigned hardware functional blocks 314 to perform the predefined IP packet process based on a process. In this regard, FIG. 4 is a flowchart of an exemplary process 400 that may be performed by the resource controller 322 in the virtualized IP packet processing system 302 of FIG. 3 for processing IP packets based on the predefined IP packet process.

With reference to FIG. 4, the resource controller 322 receives the IP process request 326(1) from the virtual client 304(1) among the virtual clients 304(1)-304(M) via the client interface 310 to perform the predefined IP packet process (block 402). In response to receiving the IP process request 326(1), the resource controller 322 defines the virtual channel 328 for the virtual client 304(1) (block 404). The resource controller 322 then assigns one or more hardware functional blocks 314 (assigned hardware functional blocks 314) among the hardware functional blocks 314(1)-314(K) to the virtual channel 328 based on the predefined IP packet process. Each of the hardware functional blocks 314(1)-314(K) is configured to perform a predefined IP packet processing function (block 406). The resource controller 322 then configures the assigned hardware functional blocks 314 to perform the predefined IP packet process according to the specified processing sequence (block 408).

A virtualized IP packet processing system according to aspects disclosed herein may be provided in or integrated into any processor-based device, such as virtualized IP packet processing system 302 of FIG. 3. Examples, without limitation, include a set top box, an entertainment unit, a navigation device, a communications device, a fixed location data unit, a mobile location data unit, a mobile phone, a cellular phone, a smart phone, a tablet, a phablet, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, and an automobile.

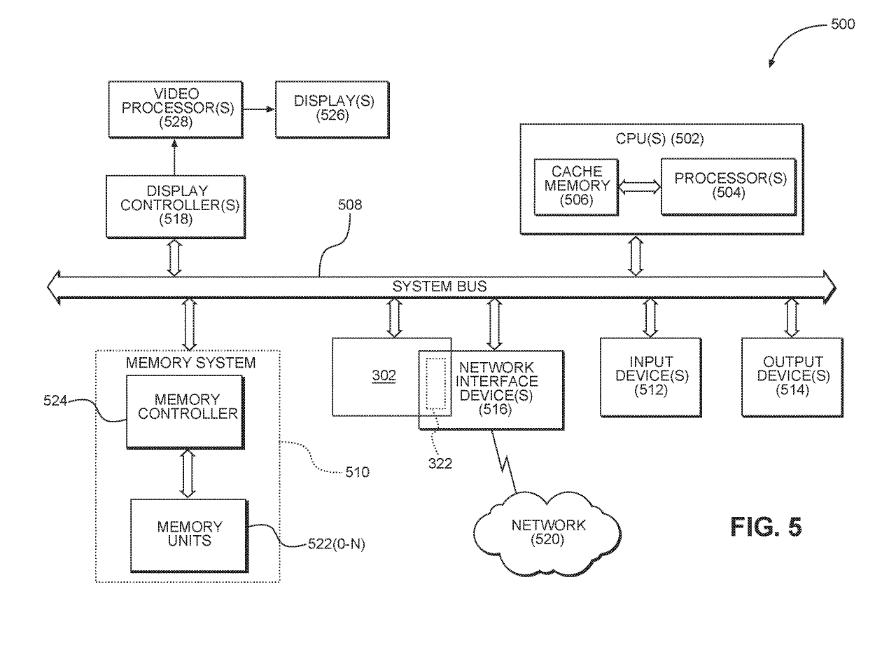

In this regard, FIG. 5 illustrates an example of a processor-based system 500 that can support the virtualized IP packet processing system 302 of FIG. 3. In this example, the processor-based system 500 includes one or more central processing units (CPUs) 502, each including one or more processors 504. The CPU(s) 502 may have cache memory 506 coupled to the processor(s) 504 for rapid access to temporarily stored data. The CPU(s) 502 is coupled to a system bus 508. As is well known, the CPU(s) 502 communicates with other devices by exchanging address, control, and data information over the system bus 508. Although not illustrated in FIG. 5, multiple system buses 508 could be provided, wherein each system bus 508 constitutes a different fabric.

Other master and slave devices can be connected to the system bus 508. As illustrated in FIG. 5, these devices can include a memory system 510, one or more input devices 512, one or more output devices 514, one or more network interface devices 516, and one or more display controllers 518, as examples. The input device(s) 512 can include any type of input device, including, but not limited to, input keys, switches, voice processors, etc. The output device(s) 514 can include any type of output device, including, but not limited to, audio, video, other visual indicators, etc. The network interface device(s) 516 can be any device configured to allow exchange of data to and from a network 520. The network interface device(s) 516 includes the network processor 322 of FIG. 3 that is configured to function as the resource controller 322 in the virtualized IP packet processing system 302. The network 520 can be any type of network, including, but not limited to, a wired or wireless network, a private or public network, a local area network (LAN), a wireless local area network (WLAN), a wide area network (WAN), a BLUETOOTH™ network, or the Internet. The network interface device(s) 516 can be configured to support any type of communications protocol desired. The memory system 510 can include one or more memory units 522(0-N) and a memory controller 524.

The CPU(s) 502 may also be configured to access the display controller(s) 518 over the system bus 508 to control information sent to one or more displays 526. The display controller(s) 518 sends information to the display(s) 526 to be displayed via one or more video processors 528, which process the information to be displayed into a format suitable for the display(s) 526. The display(s) 526 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To illustrate clearly this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A virtualized Internet Protocol (IP) packet processing system, comprising:
a client interface configured to be coupled to a plurality of virtual clients;
hardware-based IP packet processing circuitry comprising a computing circuit, the computing circuit comprising a plurality of hardware functional blocks each configured to perform a predefined IP packet processing function; and
a resource controller configured to:
receive an IP process request from a virtual client among the plurality of virtual clients via the client interface to perform a predefined IP packet process;
define a virtual channel for the virtual client;
assign one or more hardware functional blocks among the plurality of hardware functional blocks to the virtual channel based on the predefined IP packet process; and
configure the one or more assigned hardware functional blocks to perform the predefined IP packet process according to a specified processing sequence.

2. The virtualized IP packet processing system of claim 1, wherein the predefined IP packet process is an IP packet encoding process.

3. The virtualized IP packet processing system of claim 2, wherein the one or more assigned hardware functional blocks are configured to:
receive one or more application-specific packets from an input queue in a first packet order;
encode the one or more application-specific packets into one or more IP packets according to the specified processing sequence; and
add the one or more IP packets to an output queue in a second packet order.

4. The virtualized IP packet processing system of claim 3, wherein the one or more assigned hardware functional blocks are configured to add the one or more IP packets to the output queue in the second packet order identical to the first packet order.

5. The virtualized IP packet processing system of claim 3, wherein the one or more assigned hardware functional blocks are configured to add the one or more IP packets into the output queue in the second packet order different from the first packet order.

6. The virtualized IP packet processing system of claim 1, wherein the predefined IP packet process is an IP packet decoding process.

7. The virtualized IP packet processing system of claim 6, wherein the one or more assigned hardware functional blocks are configured to:
receive one or more IP packets from an input queue in a first packet order;
decode the one or more IP packets into one or more application-specific packets according to the specified processing sequence; and
add the one or more application-specific packets to an output queue in a second packet order.

8. The virtualized IP packet processing system of claim 7, wherein the one or more assigned hardware functional blocks are configured to add the one or more application-specific packets to the output queue in the second packet order identical to the first packet order.

9. The virtualized IP packet processing system of claim 7, wherein the one or more assigned hardware functional blocks are configured to add the one or more application-specific packets to the output queue in the second packet order different from the first packet order.

10. The virtualized IP packet processing system of claim 1, wherein:
the hardware-based IP packet processing circuitry further comprises storage media having a plurality of storage elements; and
the resource controller is further configured to allocate one or more storage elements among the plurality of storage elements to the virtual channel.

11. The virtualized IP packet processing system of claim 10, wherein the resource controller is further configured to allocate the one or more storage elements dynamically based on bandwidth requirement of the virtual channel.

12. The virtualized IP packet processing system of claim 10, wherein the resource controller is further configured to allocate the one or more storage elements dynamically based on latency requirement of the virtual channel.

13. The virtualized IP packet processing system of claim 10, wherein the resource controller is configured to allocate the one or more storage elements exclusively to the virtual channel.

14. The virtualized IP packet processing system of claim 1, wherein the virtual channel is associated with a respective security credential.

15. The virtualized IP packet processing system of claim 1, wherein the resource controller is a network processor.

16. The virtualized IP packet processing system of claim 1, wherein the plurality of hardware functional blocks is configured to perform the predefined IP packet processing function selected from the group consisting of: an IP packet header deciphering function; an IP packet header ciphering function; an IP packet header filtering function; an IP packet header checksum function; an IP packet header insertion function; an IP packet header removal function; an IP packet payload processing function; an IP packet aggregation function; an IP packet de-aggregation function; an IP packet routing function; and an IP packet network address translation (NAT) function.

17. The virtualized IP packet processing system of claim 1 integrated into an integrated circuit.

18. The virtualized IP packet processing system of claim 1 integrated into a device selected from the group consisting of: a set top box; an entertainment unit; a navigation device; a communications device; a fixed location data unit; a mobile location data unit; a mobile phone; a cellular phone; a smart phone; a tablet; a phablet; a server; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; and an automobile.

19. A virtualized Internet Protocol (IP) packet processing system, comprising:
a means for coupling to a plurality of virtual clients;
a means for processing IP packets comprising a computing circuit, the computing circuit comprising a plurality of hardware functional blocks each configured to perform a predefined IP packet processing function; and
a means for controlling resources configured to:
receive an IP process request from a virtual client among the plurality of virtual clients via a client interface to perform a predefined IP packet process;
define a virtual channel for the virtual client;
assign one or more hardware functional blocks among the plurality of hardware functional blocks to the virtual channel based on the predefined IP packet process; and
configure the one or more assigned hardware functional blocks to perform the predefined IP packet process according to a specified processing sequence.

20. A method for processing Internet Protocol (IP) packets, comprising:
receiving an IP process request from a virtual client among a plurality of virtual clients via a client interface to perform a predefined IP packet process;
defining a virtual channel for the virtual client;
assigning one or more hardware functional blocks among a plurality of hardware functional blocks to the virtual channel based on the predefined IP packet process, wherein each of the plurality of hardware functional blocks is configured to perform a predefined IP packet processing function; and
configuring the one or more assigned hardware functional blocks to perform the predefined IP packet process according to a specified processing sequence.

21. The method of claim 20, further comprising:
receiving one or more application-specific packets from an input queue in a first packet order;
encoding the one or more application-specific packets into one or more IP packets according to the specified processing sequence; and
adding the one or more IP packets to an output queue in a second packet order.

22. The method of claim 21, further comprising adding the one or more IP packets to the output queue in the second packet order identical to the first packet order.

23. The method of claim 21, further comprising adding the one or more IP packets to the output queue in the second packet order different from the first packet order.

24. The method of claim 20, further comprising:
receiving one or more IP packets from an input queue in a first packet order;
decoding the one or more IP packets into one or more application-specific packets according to the specified processing sequence; and
adding the one or more application-specific packets to an output queue in a second packet order.

25. The method of claim 24, further comprising adding the one or more application-specific packets to the output queue in the second packet order identical to the first packet order.

26. The method of claim 24, further comprising adding the one or more application-specific packets to the output queue in the second packet order different from the first packet order.

27. The method of claim 20, further comprising allocating one or more storage elements among a plurality of storage elements in a storage media to the virtual channel.

28. The method of claim 27, further comprising allocating the one or more storage elements dynamically based on bandwidth requirement of the virtual channel

29. The method of claim 27, further comprising allocating the one or more storage elements dynamically based on latency requirement of the virtual channel

30. The method of claim 27, further comprising allocating the one or more storage elements exclusively to the virtual channel
